(19) United States
(12) Patent Application Publication
(10) Pub. No.: US 2025/0254754 A1
(43) Pub. Date: Aug. 7, 2025

(54) Wireless Communication Methods and Device thereof

(71) Applicant: ZTE Corporation, Shenzhen (CN)

(72) Inventors: Xiaoying MA, Shenzhen (CN); Jun XU, Shenzhen (CN); Mengzhu CHEN, Shenzhen (CN); Jianqiang DAI, Shenzhen (CN); Jiajun XU, Shenzhen (CN); Hong TANG, Shenzhen (CN)

(21) Appl. No.: 18/856,669

(22) PCT Filed: Apr. 12, 2022
(86) PCT No.: PCT/CN2022/086440

§ 371 Date: Oct. 14, 2024

(51) Int. Cl. H04W 76/28; H04W 52/02

(52) U.S. Cl. CPC H04W 76/28; H04W 52/0216

(57) ABSTRACT

The present disclosure provides a wireless communication method for use in a wireless terminal. The method comprises: a radio resource control (RRC) signaling associated with a discontinuous reception (DRX) cycle of a DRX configuration is received from a wireless network node, and the DRX configuration is used to perform a DRX.

### TECHNICAL FIELD

The present disclosure relates to the field of wireless communications.

### BACKGROUND

Discontinuous reception (DRX) is a power saving technique. The basic mechanism of DRX is to configure a DRX cycle for a user equipment (UE) and a drx-onDurationTimer at the beginning of a DRX cycle.

FIG. 1 shows a schematic diagram of an exemplary DRX cycle.

When the drx-onDurationTimer is running, the UE is in a ‘DRX On’ state and continues to monitor a physical downlink control channel (PDCCH). If the UE successfully decodes information on the PDCCH, the UE stays awake (i.e. in the ‘DRX On’ state) and starts an inactivity timer. The UE may go to sleep, which means that the UE is in a ‘DRX off’ state (this is shown in FIG. 1 as “Opportunity for DRX”), after thedrx-onDurationTimer or drx-inactivityTimer has expired. In the ‘DRX off’ state, the UE does not monitor the PDCCH.

When the UE is awake or is in the “DRX On” state, the UE is in active time. When the DRX is configured, the Active Time for Serving Cells in a DRX group includes the time while:
drx-onDurationTimer or drx-InactivityTimer configured for the DRX group is running; or
drx-RetransmissionTimerDL or drx-RetransmissionTimerUL is running on any Serving Cell in the DRX group; or
ra-ContentionResolutionTimer or msgB-ResponseWindow is running; or
a Scheduling Request is sent on a physical uplink control channel (PUCCH) and is pending; or
a PDCCH indicating a new transmission addressed to a cell radio network temporary identifier (C-RNTI) of a media access control (MAC) entity has not been received after successful reception of a Random Access Response for a Random Access Preamble not selected by the MAC entity among the contention-based Random Access Preambles.

When the UE sleeps or is in the “DRX off” state, the UE is not in the active time.

The UE determines when to start the drx-onDurationTimer according to a predefined procedure, which is summarized as follows:
if a Short DRX cycle is used for a DRX group, and [(SFN×10)+subframe number] modulo (drx-ShortCycle)=(drx-StartOffset) modulo (drx-ShortCycle): start the drx-onDurationTimer for this DRX group after the drx-SlotOffset from the beginning of the subframe.
if a Long DRX cycle is used for a DRX group, and [(SFN×10)+subframe number] modulo (drx-LongCycle)=drx-StartOffset: ( . . . ) start the drx-onDurationTimer after a drx-SlotOffset from the beginning of the subframe.

FIG. 2 shows a schematic diagram of a UE determining when to start the drx-onDurationTimer based on the predefined procedure.

As shown in FIG. 2, the Drx-startOffset=6 ms, DRX cycle=7 ms, the drx-onDurationTimer=3 ms, the drx-SlotOffset=0. In SFN: 0, subframe: 6, [(0×10)+6] modulo (7)=6, the condition is satisfied and the drx-onDurationTimer is started. In SFN: 1, subframe: 3, [(1×10)+3] modulo (7)=6, the condition is satisfied and the drx-onDurationTimer is started.

With the development of wireless communication technology, the transmission rate, delay, throughput, reliability and other performance indexes of wireless communication system have been greatly improved by using high frequency band, large bandwidth, multi-antenna and other technologies.

eXtended Reality (XR) and cloud gaming are some of the most important 5G media applications under consideration in the industry. The XR includes representative forms such as Augmented Reality (AR), Mixed Reality (MR) and Virtual Reality (VR) and the areas interpolated among them.

The traffic of XR includes video, audio, pose/control, etc. The 5G services (e.g., the XR and cloud gaming services) need high reliability, high throughput and low latency. Since the XR devices include head-mounted display or glasses with standalone capability, the battery life of the XR devices has a great impact on user experience. In view of this, it is important to reduce the power consumption of the XR devices.

However, if the DRX is used in the XR services, there may be a problem of mismatch between XR traffics and the DRX cycle.

In FIG. 3, the XR traffic cycle is a non-integer value and the current DRX cycle is defined to be an integer value. The mismatch between these two cycles may lead to a large difference after several cycles. The large difference may cause the XR traffic arrives at the time interval of the “DRX off” state, resulting in increasing the active time and the power consumption and may cause large latency.

### SUMMARY

In view of the above, it is an object of the present disclosure to provide a new DRX configuration, method of DRX configuration and procedure for overcoming, among others, the above-mentioned problems.

Various embodiments may preferably implement the following features:

The present disclosure relates to a wireless communication method for use in a wireless terminal. The method comprises:
receiving, from a wireless network node, a radio resource control, RRC, signaling associated with a discontinuous reception, DRX, cycle of a DRX configuration, and
using the DRX configuration to perform a DRX.

Various embodiments may preferably implement the following features:

Preferably, the RRC signaling comprises a value used for determining a non-integer value as the DRX cycle.

Preferably, the DRX cycle is a non-integer value determined by:

$$\frac{1000}{A} ( ms )$$

wherein the value A is indicated by the RRC signaling or the value A is a frame per second parameter configured in the RRC signaling.

Preferably, the RRC signaling comprises a non-integer value of the DRX cycle.

Preferably, the RRC signaling comprises at least one of a frame per second parameter, a quality-of-service parameter or a data rate parameter used to determine a non-integer value of the DRX cycle.

Preferably, a unit of at least one parameter of the DRX configuration is millisecond.

Preferably, the RRC signaling does not comprise a DRX long cycle of the DRX configuration.

Preferably, the wireless communication method further comprises ignoring a DRX long cycle in the RRC signaling.

Preferably, the wireless communication method further comprises disabling a DRX short cycle of the DRX.

Preferably, the DRX cycle is a non-integer value having F decimal places, wherein F is a positive integer.

Preferably, the RRC signaling indicates at least one parameter used to determine at least one of a DRX long cycle, the DRX cycle or a start offset of the DRX configuration, wherein the at least one parameter comprises at least one of: a change offset, a change cycle, or a change time.

Preferably, the DRX cycle is determined according to a change time and a change cycle,
wherein the DRX cycles in one change cycle is determined by:
a value of each of first (change cycle−1) DRX cycles is equal to function(change time/change cycle),
a value of the last DRX cycle is equal to Change time−(Change cycle−1)*function(change time/change cycle)
wherein the function is a round function, a round up function, a round down function or a function of keeping the original value.

Preferably, a start offset of the DRX configuration is smaller than a maximum integer which is smaller than a non-integer value of the DRX cycle.

Preferably, a start offset of the DRX configuration is determined based on at least one parameter associated with jitter.

Preferably, the at least one parameter associated with jitter comprises at least one of:
a jitter window indicating a time range of the jitter, or
a jitter offset indicating an offset between a time of generating a packet and a time of arrival of the packet.

Preferably, using the DRX configuration to perform the DRX comprises at least one of:
starting an on-duration timer or starting the on-duration timer after a slot offset at a time-domain position if a predefined condition is satisfied, or
monitoring a physical downlink control channel (PDCCH) according to the DRX configuration.

Preferably, he predefined condition comprises at least one of:
the RRC signaling associated with the non-integer value is configured,
the RRC signaling indicating at least one parameter used to adjust or determine at least one of a DRX long cycle, a DRX cycle or a start offset of the DRX configuration is configured,
an enabling signaling associated with the DRX cycle of the DRX configuration is configured, or
a functional relationship is satisfied.

Preferably, the functional relationship is associated with at least one of a hyper system frame number, a reference system frame number, a reference subframe number, a system frame number, a subframe number, a frame per second, an index or a fixed value, a DRX cycle of the DRX configuration, a start offset of the DRX configuration, a change offset, a change time, or a change cycle.

Preferably, the functional relationship comprises:
a first difference between a second difference and a start offset of the DRX configuration is smaller than 1 and is greater than or equal to 0, wherein the second difference is between a total subframe number of subframes before the time-domain position and a total time of DRX cycles before the time-domain position.

Preferably, the functional relationship comprises:
a second difference is equal to a start offset of the DRX configuration,
wherein the second difference is between a total subframe number of subframes before the time-domain position and a total time of DRX cycles before the time-domain position.

Preferably, the total time of the DRX cycles before the time-domain position is determined by:

$$function ( \frac{SFN \times 10 + subframenumber}{drx - cycle} ) \times ( drx - cycle ) ,$$

wherein SFN is a system frame number corresponding to the time-domain position, subframe number is a subframe index corresponding to the time-domain position, drx-cycle is the value of the DRX cycle, and function is round, round down, round up or keep the original value.

Preferably, the second difference is rounded up to a minimum integer greater than the second difference or is rounded down to a maximum integer smaller than the second difference or is rounded to an integer.

Preferably, the total time of DRX cycles before the time-domain position is rounded up to a minimum integer greater the total cycle number or is rounded down to a maximum integer smaller than the total cycle number or rounded to an integer.

Preferably, the functional relationship comprises:
a third difference between a remainder and a start offset of the DRX configuration is smaller than 1 and is greater than or equal to 0, wherein the remainder is determined by a division of a total subframe number of subframes before the time-domain position by the DRX cycle.

Preferably, the functional relationship comprises:
a remainder is equal to a start offset of the DRX configuration, wherein the remainder is determined by a division of a total subframe number of subframes before the time-domain position by the DRX cycle.

Preferably, the remainder is rounded up to a minimum integer greater than the remainder or is rounded down to a maximum integer smaller than the remainder or round.

Preferably, the functional relationship comprises:
a remainder of a division of a total subframe number of subframes before the time-domain position by a DRX long cycle of the DRX configuration is equal to a function of a start offset of the DRX configuration, a change offset, and a change time,
wherein the function is a remainder of a division of a modified start offset by the DRX cycle, and
wherein the modified start offset is a sum of the start offset and a modified value.

Preferably, the modified value is a product of a change offset and a function of a division of the total subframe number of subframes before the time-domain position by the change time, wherein the function is round up, round down, round, or keep the original value.

Preferably, the functional relationship comprises:
a remainder of a division of a total subframe number of subframes before the time-domain position by a DRX cycle of the DRX configuration is equal to a start offset of the DRX configuration,
wherein at least one of the long DRX cycle or the start offset is determined according to a change offset comprised in the RRC signaling.

Preferably, the start offset is determined according to the change offset comprised in the RRC signaling by:
if the total subframe number of subframes before the time-domain position is greater than the start offset, and a remainder of a division of the total subframe number of subframes before the time-domain position by the change time is equal to an integer, wherein the integer is smaller than the change time,
the start offset is a value of a sum of the start offset and the change offset;
otherwise, the start offset remains the same.

Preferably, the integer smaller than the change time is predefined or configured by the RRC signaling or configured to be the same with the start offset.

Preferably, the start offset is adjusted to be a remainder of a division of the start offset by the DRX cycle.

Preferably, the functional relationship comprises the time domain position is a subframe corresponding to:

$$reference SFN \times 10 + function ( j \times DRXcycle ) , or$$

$$reference SFN \times 10 + reference subframe number + function ( j \times DRXcycle ) ,$$

where reference SFN is a system frame number configured by the RRC signaling, reference subframe number is a subframe number configured by the RRC signaling, j is an integer greater than or equal to 0, and function is a round up function or round down function or a function of keeping the original value.

Preferably, the total subframe number of subframes before the time-domain position is determined by:

$$SFN \times 10 + subframenumber ,$$

$$( SFN - reference SFN ) \times 10 + subframenumber , ( H - SFN - reference H - SFN ) * 1024 * 10 + SFN \times 10 + subframenumber ,$$

$$H - SFN * 1024 * 10 + SFN * 10 + subframe number , or$$

$$SFN \times 10 + subframenumber - startoffset$$

where SFN is a system frame number corresponding to the time-domain position and subframe number is a subframe index corresponding to the time-domain position, and H-SFN is a hyper system frame number, reference H-SFN is a reference hyper system frame number configured by the RRC signaling.

The present disclosure relates to a wireless communication method for use in a wireless network node. The method comprises transmitting, to a wireless terminal, a radio resource control, RRC, signaling associated with a discontinuous reception, DRX, cycle of a DRX configuration.

Various embodiments may preferably implement the following features:

Preferably, the RRC signaling comprises a value used for determining a non-integer value as the DRX cycle.

Preferably, the DRX cycle is a non-integer value determined by:

$$\frac{1000}{A} ( ms )$$

wherein the value A is indicated by the RRC signaling or the value A is a frame per second parameter configured in the RRC signaling.

Preferably, the RRC signaling comprises a non-integer value of the DRX cycle.

Preferably, the RRC signaling comprises at least one of a frame per second parameter, a quality-of-service parameter or a data rate parameter used to determine a non-integer value of the DRX cycle.

Preferably, a unit of at least one parameter of the DRX configuration is millisecond.

Preferably, the RRC signaling does not comprise a DRX long cycle of the DRX configuration.

Preferably, the DRX cycle is a non-integer value having F decimal places, wherein F is a positive integer.

Preferably, the RRC signaling indicates at least one parameter used to determine at least one of the DRX cycle, a DRX long cycle or a start offset of the DRX configuration.

Preferably, the RRC signaling indicates at least one of:
a change offset, used to determine at least one of a DRX long cycle or a start offset of the DRX configuration,
a change cycle, indicating a cycle number used to determine the change offset, or
a change time, indicating a time used to determine at least one of a change in the DRX long cycle or in a start offset of the DRX configuration.

Preferably, a start offset of the DRX configuration is smaller than a maximum integer which is smaller than the non-integer value.

Preferably, a start offset of the DRX configuration is determined based on at least one parameter associated with jitter.

Preferably, the at least one parameter associated with jitter comprises at least one of
a jitter window indicating a time range of the jitter, or
a jitter offset indicating an offset between a time of generating a packet and a time of arrival of the packet.

The present disclosure relates to a wireless terminal. The wireless terminal comprises:
a communication unit, configured to receive, from a wireless network node, a radio resource control, RRC, signaling associated with a discontinuous reception, DRX, cycle of a DRX configuration, and
a processor, configured to using the DRX configuration to perform a DRX.

Various embodiments may preferably implement the following feature:

Preferably, the processor is further configured to perform any of the aforementioned wireless communication methods.

The present disclosure relates to a wireless network node. The wireless network node comprises:
communication unit, configured to perform transmit, to a wireless terminal, a radio resource control, RRC, signaling associated with a discontinuous reception, DRX, cycle of a DRX configuration.

Various embodiments may preferably implement the following feature:

Preferably, the wireless network node further comprises a processor configured to perform any of aforementioned wireless communication methods.

The present disclosure also relates to a computer program product comprising a computer-readable program medium code stored thereupon, the code, when executed by a processor, causing the processor to implement a wireless communication method recited in any one of foregoing methods.

The wireless communication methods provided in the present disclosure have good backward compatibility. In addition, because the high layer signaling (i.e. RRC signaling) is used, the signal overhead of Layer 1 (L1) signaling can be saved.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of an exemplary DRX cycle.

FIG. 2 shows a schematic diagram of a UE determining when to start the drx-onDurationTimer.

FIG. 3 a schematic diagram of the mismatch between the XR traffic and the DRX cycle.

FIG. 4 shows a schematic diagram of a wireless terminal according to an embodiment of the present disclosure.

FIG. 5 shows a schematic diagram of a wireless network node according to an embodiment of the present disclosure.

FIG. 6 shows a UE determining when to start the drx-onDurationTimer according to an embodiment of the present disclosure.

FIGS. 7 and 8 are flowcharts of methods according to embodiments of the present disclosure.

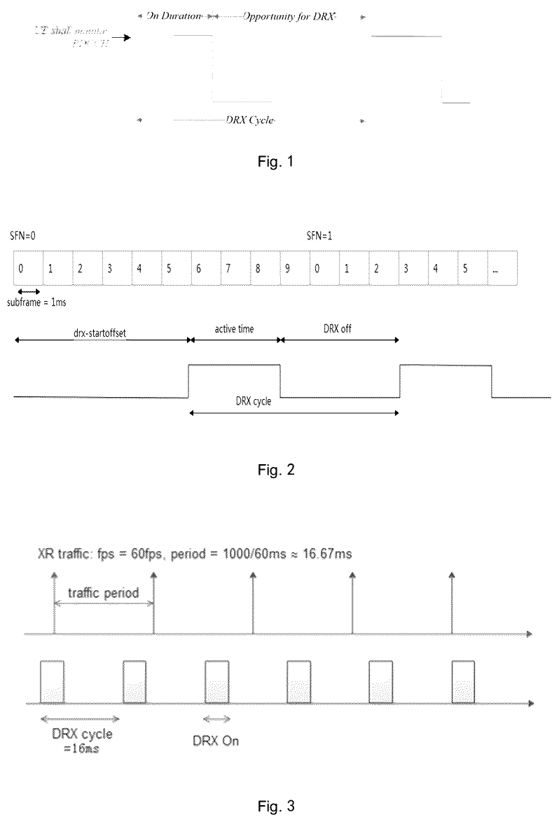

### DETAILED DESCRIPTION OF THE EMBODIMENTS

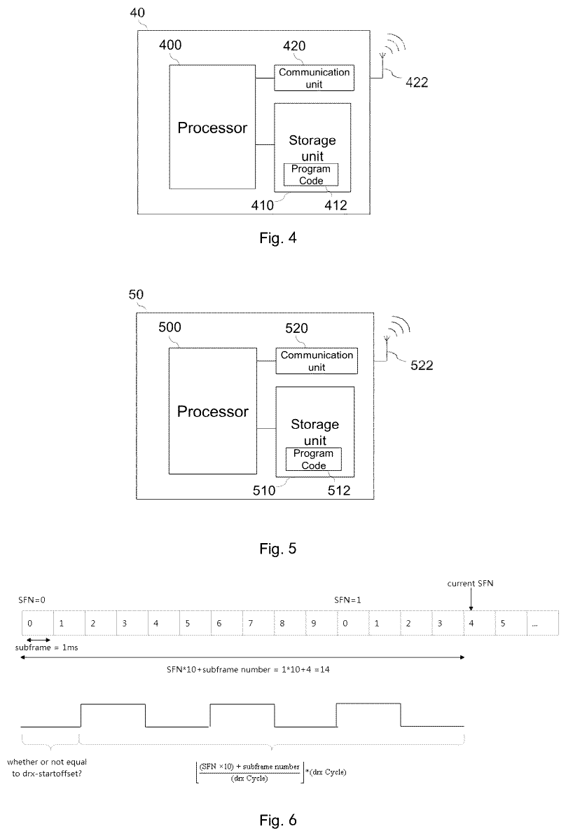

FIG. 4 relates to a schematic diagram of a wireless terminal 40 according to an embodiment of the present disclosure. The wireless terminal 40 may be a user equipment (UE), a mobile phone, a laptop, a tablet computer, a wearable glass, a Head-Mounted Display, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 410 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g. messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g. a base station).

FIG. 5 relates to a schematic diagram of a wireless network node 50 according to an embodiment of the present disclosure. The wireless network node 50 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 510 include but are not limited to a SIM, ROM, flash memory, RAM, hard-disk, and optical data storage device. The communication unit 520 may be a transceiver and is used to transmit and receive signals (e.g. messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g. a user equipment or another wireless network node).

In the present disclosure, a long DRX cycle may be equal to a DRX long cycle or drx-LongCycle.

In the present disclosure, a short DRX cycle may be equal to a DRX short cycle or drx-ShortCycle.

Currently, the choice of drx-LongCycleStartOffset is defined as follows (note that in the prior art, drx-LongCycle candidate values are integer values):

| | |
|---|---|
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},
drx-LongCycleStartOffset
drx-LongCycle in ms and drx-StartOffset in multiples of 1 ms. If drx-ShortCycle is
configured, the value of drx-LongCycle shall be a multiple of the drx-ShortCycle
value.

In an embodiment, a new DRX cycle is associated with/configured by an RRC (radio resource control) signaling. In the present disclosure, the new DRX cycle may be a non-integer DRX cycle (i.e. a DRX cycle having a non-integer value). In the following, the new DRX cycle may be equal to DRX cycle for simplifying illustrations. In some embodiments, the new DRX cycle may be configured as the integer DRX cycle and an average DRX cycle of the DRX performed based on the RRC signaling (and corresponding DRX configuration) is an non-integer value.

In an example of the embodiment, the RRC signaling may indicate a value A, where the new DRX cycle is equal to 1000/A ms.

In some embodiments, A is an integer value larger than 0 and less than or equal to 500.

In some embodiments, A is a multiple of 3 or 5 or 10.

In some embodiments, A is an even number.

In some embodiments, the candidate values of A at least include 30, 60, 90, 120.

In some embodiments, A is an FPS (frames per second) value.

In some embodiments, a step of the candidate values of A is 10.

In another example of the embodiment, the RRC signaling may indicate a numerator value B and a denominator value C. The new DRX cycle is equal to B/C ms, wherein B and C are integer values larger than 0.

In another example of the embodiment, the RRC signaling may indicate a non-integer value T, where the DRX cycle is equal to T.

In some embodiments, T is a fraction described in numerator and denominator form, such as, for example, 100/3, 50/3, etc.

In some embodiments, T is a fraction in decimal form such as, for example, 16.67, 33.33, etc.

In some embodiments, T is greater than 0 and less than or equal to 100.

In another example of the embodiment, the DRX configuration includes or is associated with an RRC parameter of the FPS.

In some embodiments, the RRC signaling indicates an FPS value. The new DRX cycle is derived according to the FPS value. For example, the new DRX cycle is determined as 1000/FPS ms. In some embodiments, a step of the candidate values of the FPS is 10. In some embodiments, the FPS is a multiple of 3 or 5 or 10. In some embodiments, the candidate values of the FPS at least include 30, 60, 90, and 120.

In some embodiments, the new DRX cycle is associated with a QoS (Quality of service) parameter (in the RRC signaling).

In some embodiments, the new DRX cycle is associated with a data rate or the FPS (in the RRC signaling).

In some embodiments, the RRC signaling is the original RRC signaling (e.g. the RRC signaling used in Release 15,16,17) or a new RRC signaling (e.g., new RRC signaling used at least in Release18). For example, the new DRX cycle may be configured by using the DRX long cycle or the DRX short cycle in the original RRC signaling.

In some embodiments, if the new RRC signaling (e.g. new DRX cycle signaling or FPS signaling or the RRC signaling used to determine the new DRX cycle) is configured, the DRX long cycle may not be configured. The reason for this is that, since the new DRX cycle can be obtained according to the FPS value, no more DRX long cycle is needed.

In some embodiments, the new RRC signaling used to determine the new DRX cycle and the DRX long cycle may not be configured simultaneously. In another word, the UE does not expect to be configured with the DRX long cycle and the new DRX cycle simultaneously. In some embodiments, the DRX long cycle means the DRX cycle is configured by an original RRC signaling.

In some embodiments, if the new RRC signaling used to determine the new DRX cycle is configured, the DRX long cycle, if configured, may be ignored.

In some embodiments, if the new RRC signaling used to determine the new DRX cycle is configured, the short DRX cycle may not be enabled (i.e. may be disabled) when performing the DRX (operation).

In some embodiments, if the new RRC signaling used to determine the new DRX cycle is configured, the RRC signaling associated with the short DRX cycle (e.g., shortDRX, drx-ShortCycle, drx-ShortCycleTimer) may not be configured. In other words, the new RRC signaling used to determine the new DRX cycle and the RRC signaling associated with the short DRX cycle are not configured simultaneously.

In some embodiments, if the new RRC signaling used to determine the new DRX cycle is configured, the RRC signaling associated with the short DRX cycle (e.g., shortDRX, drx-ShortCycle, drx-ShortCycleTimer) may be ignored.

In some embodiments, if the DRX cycle is a non-integer (value), the non-integer value keeps/has F decimal places. In some embodiments, the new DRX cycle is directly indicated as a non-integer value or is derived as a non-integer value according to other parameter(s).

In some embodiments, F is an integer greater than 0.

In some embodiments, the value of the new DRX cycle is rounded down. For example, if F=2 and the DRX cycle is 1000/60, the DRX cycle=16.66 ms.

In some embodiments, the value of the new DRX cycle is rounded up. For example, if F=2 and the DRX cycle is 1000/60, the DRX cycle=16.67 ms.

In some embodiments, the value of the new DRX cycle is rounded. For example, if F=2 and the DRX cycle is 1000/60, the DRX cycle=16.67 ms. If F=2 and the DRX cycle is 25/3, the DRX cycle=8.33 ms.

In some embodiments, the RRC signaling indicates a change offset (C_offset) and/or a change cycle (C_cycle) and/or a change time (C_time). The change offset may be a value used to change/determine the drx-longcyle or the drx-startOffset. The change cycle may indicate a cycle number. The change time may indicate a value used to determine a change in the DRX long cycle or in a start offset corresponding to the DRX long cycle of the DRX. In some embodiments, the change offset may be a value used to determine the drx-longcyle or the drx-startOffset. The change cycle may indicate a cycle number. The change time may indicate a value used to determine the DRX long cycle or a start offset corresponding to the DRX long cycle of the DRX. In some embodiments, changing or determining in the DRX long cycle or the start offset by using the change offset (C_offset) and/or a change cycle (C_cycle) and/or a change time (C_time) does not mean that the value of the DRX long cycle or the start offset configured by the RRC signaling is changed by the change offset (C_offset) and/or a change cycle (C_cycle) and/or a change time (Cltime). Rather, it may denote executing a function related to ‘the DRX long cycle or start offset‘by using’ the change offset (C_offset) and/or a change cycle (C_cycle) and/or a change time (C_time)’.

In some embodiments, the UE may change/determine the drx-long cycle and/or the drx-startOffset according to the change offset and/or the change cycle.

In an embodiment, candidate values of drx-startOffset associated with the non-integer DRX cycle may be different from the original candidate values of the drx-startOffset associated with the integer DRX cycle. For example, the original candidate values of the drx-startOffset may be those of the drx-startOffset in NR Release 15,16 or 17.

In some embodiments, the candidate value of drx-startOffset is an integer smaller than the DRX cycle and greater than or equal to 0.

In some embodiments, the step of the candidate value drx-startOffset is 1.

In some embodiments, the new start offset is a new RRC parameter. Note that the new start offset is a start offset used for/associated with/configured for/related to the new DRX cycle (e.g. non-integer DRX cycle). This new RRC parameter may be associated with the new RRC signaling used to obtain the value of the new DRX cycle.

In some embodiments, the maximum candidate value of the new start offset is smaller than or equal to the value of rounding down the new DRX cycle (i.e. round down (new DRX cycle)). In some embodiments, new start offset means start offset used with a non-integer DRX cycle.

In some embodiments, the new start offset is associated with a length of jitter window and/or a jitter offset. The length of a jitter window means the range of jitter offset. For example, if the jitter is [−4 ms, 4 ms], the length of jitter window is 8 ms. The jitter offset means the offset between a first reference time and a second reference time. The first reference time may be the packet generation time. The second reference time may be the packet arrival time. Packet arrival time is the time when a packet arrives at gNB. Note that the drx-startOffset (i.e. the start offset corresponding to DRX long cycle) may also be associated with the length of jitter window and/or the jitter offset.

In some embodiments, the maximum candidate value of new start offset is an integer smaller than a value E (e.g., the maximum candidate value of new start offset is E-1), where E is a multiple of 10 and is less than the new DRX cycle. For example, if the new DRX cycle=1000/60 ms, the value E=10 and the maximum candidate value of new start offset is 9.In some embodiments, the maximum candidate value of new start offset is an integer smaller than or equal to a value E, where E is a multiple of 10 and is less than the DRX cycle.

In some embodiments, if the new start offset is configured, the original drx-startOffset may not be configured. In the present disclosure, the new start offset is the start offset associated with a non-integer DRX cycle and the original drx-startOffset is the drx-startOffset associated with an integer DRX cycle.

In some embodiments, the RRC signaling associated with/comprising/indicating/configuring the new start offset and the original RRC signaling associated with/comprising/indicating/configuring the drx-startOffset may be configured simultaneously.

In some embodiments, if the new start offset is configured, the original drx-startOffset, if configured, may be ignored.

In some embodiments, a new offset parameter is configured in the RRC signaling, wherein the new offset parameter is used to modify/change/adjust the original start offset (i.e. drx-startOffset). That is, in these embodiments, the configured drx-startOffset is still used and the new offset parameter is configured. The UE uses calculates ‘original start offset+new offset parameter value’ as the start offset used in the DRX (operation).

In some embodiments, one DRX configuration may at least have one set of following parameters/signaling:
Set 1: original DRX long cycle, change time or change cycle or change offset;
Set 2: RRC signaling associate with the new DRX cycle, original start offset;
Set 3: RRC signaling associate with the new DRX cycle, new start offset;
Set 4: RRC signaling associate with the new DRX cycle, original start offset, new offset parameter;
Set 5: original start offset, change time or change cycle or change offset.

In some embodiments, the DRX configuration with any one of the above sets is represented as a new DRX configuration.

The new RRC signaling may denote at least one of the following: RRC signaling associate with at least one of the new DRX cycle, the new start offset, the new offset parameter change time, change cycle, change offset.

In an embodiment, there is provided a method for determining when to start the drx-onDurationTimer if the non-integer DRX cycle used. In some embodiment, there is provided a method for determining when to start the drx-onDurationTimer if a new RRC signaling is used.

The method comprises:
starting the drx-onDurationTimer or starting the drx-onDurationTimer after the drx-SlotOffset from the beginning of the subframe if a predefined condition is satisfied. The predefined condition includes at least one of the following:
a. a new RRC signaling is configured. This may include at least one of:
a.1 a new RRC signaling used to determine the new DRX cycle is configured;
a.2 an RRC signaling associated with a non-integer DRX cycle is configured;
a.3 an RRC signaling indicating an FPS is configured; and
a.4 an RRC signaling indicating a change offset and/or a change cycle and/or a change time is configured;
b. an enable signaling is configured; and
c. a functional relationship is satisfied.

In some embodiments, the predefined condition is satisfied if at least a functional relationship is satisfied. In this embodiment, the functional relationship may be associated with at least one of the following: SFN (system frame number), subframe number, DRX cycle, FPS, drx-startOffset, an index, a fixed value, a H-SFN (hyper system frame number), a change offset, a change cycle, a change time.

In some embodiments, the new DRX cycle is obtained by an explicit indication or implicit indication. The explicit indication means that the DRX cycle is indicated by an RRC signaling (e.g., an RRC signaling indicating a value for the DRX cycle). The implicit indication means that the new DRX cycle is derived from an RRC signaling (e.g., an RRC signaling indicating an FPS and the new DRX cycle is equal to 1000/FPS ms).

In some embodiments, the functional relationship is a difference X between ‘current total subframe number’ and ‘current past DRX cycle time’ is equal to or approximately equal to drx-startOffset. The current total subframe number is the number of subframes before the current time-domain position (e.g. the number of subframes having passed within the interval from system frame:0 to the current time-domain position). The current past DRX cycle time is the total time of DRX cycles before the current time-domain position (e.g. the total time of DRX cycles having passed within the interval from the system frame:0 to the current time-domain position). In some embodiments, the difference X may be rounded up or down or round down, take an absolute value or remain the same. In some embodiments, ‘current past DRX cycle time’ may be rounded up or down or round or remains the same. In the present disclosure, “Approximately equal to” means that the difference X is greater than or equal to 0 and less than 1. In another example, “Approximately equal to” means that the difference X is greater than or equal to 0 and less than or equal to 1. Some examples related to this embodiment are disclosed in more detail herein below—see, e.g., examples 1, 2 and 4. In some embodiments, the difference between A and B means subtracting B from A. In another embodiment, the difference between A and B means subtracting A from B.

In some embodiments, the number of subframes before the current time-domain position is the number of subframes/slots/milliseconds from a first reference point to the current time-domain position. In some embodiments, the number of subframes before the current time-domain position is the number of subframes from a first subframe after a first reference point to the current time-domain position. In some embodiments, the first reference point is associate with a reference subframe number or a reference SFN or a reference H-SFN. The reference subframe number or a reference SFN or a reference H-SFN is configured by high layer signaling or indicated by a DCI or predefined. In some embodiments, the first reference point is same as start offset. In other words, an RRC signaling indicating a start offset also indicates the first reference point.

In some embodiments, the start offset indicates an offset between a first reference point and a first position in which to start the drx-onDurationTimer. In some embodiments, the start offset indicates an offset between a first subframe after a first reference point and a first position in which to start the drx-onDurationTimer. In some embodiments, between A and B means from A to B. In some embodiments, the subframe(s) between A and B or from A to B include the subframe of A but not include the subframe of B. In some embodiments, the subframe(s) between A and B or from A to B does not include subframes of A and B.

The first reference point is one of the following: a first subframe in a reference SFN which is indicated by a high layer signaling, the reference subframe in a reference SFN which is indicated by a high layer signaling, first subframe in SFN 0, a first subframe in SFN 0 in a H-SFN, a first subframe in a reference SFN in a reference H-SFN, where the reference SFN or reference H-SFN is indicated by a high layer signaling, the reference subframe in a reference SFN in a H-SFN which is indicated by a high layer signaling, a reference subframe in which receive a L1 signaling (e.g., a DCI) or a MAC CE signaling, a reference subframe in which UE transmit an ACK for a L1 signaling or a MAC CE signaling, a first subframe in a SFN in which receive a L1 signaling (e.g., a DCI) or a MAC CE signaling, a first subframe in a SFN in which UE transmit an ACK for a L1 signaling or a MAC CE signaling. In some embodiments, the high layer signaling is an RRC signaling or a MAC CE signaling. In some embodiments, the DCI or the MAC CE signaling is used to activate a new DRX configuration.

In some embodiments, the functional relationship is whether the remainder of the division of ‘current total subframe number’ by ‘new DRX cycle’ is equal to or approximately equal to the drx-startOffset. In some embodiments, the remainder of the division of ‘current total subframe number’ by ‘new DRX cycle’ may be rounded up or down or rounded or remain the same. Some examples related to this embodiment are disclosed in more detail herein below—see, e.g., examples 3 and 5. In some embodiments, the remainder of the division of ‘A’ by ‘B’ means A modulo B or mod(A,B).

In some embodiments, the functional relationship is whether the remainder of the division of ‘current total subframe number’ by ‘DRX cycle’ is equal to the drx-startOffset. In some embodiments, the DRX cycle or start offset may be changed. An example related to this embodiment is disclosed in more detail hereinbelow—see, e.g., example 6 in the following.

In some embodiments, the drx-startOffset may be changed. An example related to this embodiment is disclosed in more detail hereinbelow—see, e.g., example 7 in the following. In some embodiments, drx-startOffset is changed if SFN is 1023. In some embodiments, drx-startOffset is changed if SFN is change from 1023 to 0. In some embodiments, drx-startOffset is changed if SFN is back to 0. In some embodiments, drx-startOffset is changed according to a change offset if SFN is 1023. In some embodiments, drx-startOffset is changed according to a change offset if SFN is change from 1023 to 0. In some embodiments, drx-startOffset is changed according to a change offset if SFN is back to 0.

### Example 1

FIG. 6 shows a UE determining when to start the drx-onDurationTimer according to an embodiment of the present disclosure.

In this example, the functional relationships associated with SFN, subframe number, DRX cycle, and drx-startOffset). in some embodiments, the DRX configuration may at least include Set 2 or Set 3 or Set 4 signaling.

The specific functional relationship may be one of the following FRI to FR4:

$$[ ( SFN \times 10 ) + subframe number ] - function ( function ( \frac{( SFN \times 10 ) + subframe number}{( Drx cycle )} ) \times ( DRX cycle ) ) = ( drx - startoffset ) ; \qquad FR1$$

$$[ ( ( SFN - reference SFN ) \times 10 ) + subframe number ] - function ( function ( \frac{( ( SFN - reference SFN ) \times 10 ) + subframe number}{( Drx cycle )} ) \times ( Drx cycle ) ) = ( drx - startoffset ) ; \qquad FR2$$

$$function ( function ( \frac{( SFN \times 10 ) + subframe number}{( Drx cycle )} ) \times ( Drx cycle ) ) + [ ( SFN \times 10 ) + subframe number ] = ( drx - startoffset ) ; \qquad FR3$$

$$function ( function ( \frac{( SFN \times 10 ) + subframe number}{( Drx cycle )} ) \times ( Drx cycle ) ) - [ ( SFN \times 10 ) + subframe number ] = ( drx - startoffset ) . \qquad FR4$$

Wherein:
function ( ) may be a ceil(ing) function, a floor function, a round function, a round up function, a round down function, or a function of keeping the original value. In some embodiments, ceil means round up and floor means round down. In one functional relationship, different function ( ) may be different or the same. For example, FRI may be:

$$[ ( SFN \times 10 ) + subframe number ] - ceil ( floor ( \frac{( SFN \times 10 ) + subframe number}{( Drx cycle )} ) \times ( DRX cycle ) ) = ( drx - startoffset ) , or$$

$$[ ( SFN \times 10 ) + subframe number ] - floor ( floor ( \frac{( SFN \times 10 ) + subframe number}{( Drx cycle )} ) \times ( DRX cycle ) ) = ( drx - startoffset ) .$$

Specifically, (SFN*10)+subframe number denotes the ‘current total subframe number’ starting from SFN=0 and subframe 0 (i.e. subframe with the index 0) to the current SFN and current subframe (i.e. “current total subframe number”);

$$function ( \frac{( SFN \times 10 ) + subframe number}{( Drx cycle )} )$$

denotes the number of multiple DRX cycles before the current subframe;

$$function ( \frac{( SFN \times 10 ) + subframe number}{( Drx cycle )} ) \times ( Drx cycle )$$

denotes the total time of the multiple DRX cycles before the current subframe (i.e. ‘current past DRX cycle time’).

Since the new DRX cycle is a non-integer value and the other parameters (e.g., subframe number, drx-startOffset) are represented by an integer value, the function ( ) may be used.

In the above functional relationships, the total time (integer value) of maximum number of DRX cycles during the total subframe number can be derived. Whether the difference between ‘current total subframe number’ and the ‘current past DRX cycle time’ is equal to drx-startOffset (i.e. whether the functional relationship is satisfied) can be determined.

### Example 2

In some embodiments, the DRX configuration may at least include Set 2 or Set 3 or Set 4 signaling. The function relationship may be associated with SFN, subframe number, Drx cycle, drx-startOffset, and an index j. The specific functional relationship may comprise one of:

$$function ( j \times ( Drx cycle ) ) - [ ( SFN \times 10 ) + subframe number ] = ( drx - startOffset ) ;$$

$$[ ( ( SFN - reference SFN ) \times 10 ) + subframe number ] - function ( j \times ( Drx cycle ) ) = ( drx - startOffset ) ;$$

$$[ ( SFN \times 10 ) + subframe number ] - function ( j \times ( Drx cycle ) ) = ( drx - startOffset ) .$$

where function ( ) may be a ceil(ing) function, a floor function, a round function, a round up function, a round down function, or a function of keeping the original value.
where j is an integer equal to or greater than 0 (e.g., j=[0, 1, 2, . . . ]). In an embodiment, each location of a starting drx-onDurationTimer is associated with a value of j. In some embodiments, j means the j-th DRX cycle counting from the SFN:0 subframe:0. In some embodiments, one candidate value of j is associated with one DRX cycle. In some embodiments, j means the j-th DRX cycle.

The difference between example 1 and example 2 is that the number of DRX cycles placed in the previous total subframe number is represented by j, where j×(drx cycle) represents ‘current past DRX cycle time’.

### Example 3

In some embodiments, the DRX configuration may at least include Set 2 or Set 3 or Set 4 signaling. In this example, the function relationship is associated with the SFN, subframe number, drx cycle, drx-startOffset and a fixed value. The specific functional relationship may comprise one of as follows:

$$0 \leq [ ( SFN \times 10 ) + subframe number ] modulo ( drx cycle ) - ( drx - startOffset ) < 1 ;$$

$$0 \leq ( drx - startOffset ) - [ ( SFN \times 10 ) + subframe number ] modulo ( drx cycle ) < 1$$

In detail, by using [(SFN×10)+subframe number] modulo (DRX Cycle), the remainder can be obtained. Since the new DRX cycle is non-integer and [(SFN×10)+subframe number] is an integer, the remainder may be a non-integer or an integer.

The drx-startOffset is an integer. Therefore, the result of the remainder minus the drx-startOffset may be a non-integer or an integer. Hence, an inequality is used in this example.

For example, if the drx cycle=1000/30 ms, drx-startOffset=3 ms, one occasion that the inequality is satisfied is SFN=0, subframe number=3; another occasion that the inequality is satisfied is SFN=3, subframe number=4.

### Example 4

In some embodiments, the DRX configuration may at least include Set 2 or Set 3 or Set 4 signaling. In this example, the functional relationship is associated with the SFN, subframe number, drx cycle, drx-startOffset, and a fixed value. The specific functional relationship may be one of:

$$0 \leq [ ( SFN \times 10 ) + subframe number ] - function ( \frac{[ ( SFN \times 10 ) + subframe number ]}{drxCycle} ) \times ( drxCycle ) - ( drx - startOffset ) < 1 ;$$

$$0 \leq function ( \frac{[ ( SFN \times 10 ) + subframe number ]}{drxCycle} ) \times ( drxCycle ) - [ ( SFN \times 10 ) + subframe number ] + ( drx - startOffset ) < 1 ;$$

$$0 \leq function ( \frac{[ ( SFN \times 10 ) + subframe number ]}{drxCycle} ) \times ( drxCycle ) - [ ( SFN \times 10 ) + subframe number ] - ( drx - startOffset ) < 1 ;$$

$$0 \leq \vert function ( \frac{[ ( SFN \times 10 ) + subframe number ]}{drxycle} ) \times ( drxCycle ) - [ ( SFN \times 10 ) + subframe number ] + ( drx - startOffset ) \vert < 1.$$

where function ( ) may be a ceil function, a floor function, a round function, a round up function, a round down function, or a function of keeping the original value.

The definitions of each of the above elements is the same as abovementioned embodiments/examples.

### Example 5

In some embodiments, the DRX configuration may at least include Set 2 or Set 3 or Set 4 signaling. The functional relationship is associated with the SFN, subframe number, DRX cycle, and drx-startOffset. The specific functional relationship may be one of:

$$function ( [ ( SFN \times 10 ) + subframe number ] modulo ( drx cycle ) ) = ( drx - startOffset ) ;$$

$$function ( [ ( ( SFN - reference SFN ) \times 10 ) + subframe number ] modulo ( drx cycle ) ) = ( drx - startOffset ) ; 0 \leq ( [ ( SFN \times 10 ) + subframe number ] modulo ( drx cycle ) ) - ( drx - startOffset ) < 1$$

$$0 \leq ( drx - startOffset ) - ( [ ( SFN \times 10 ) + subframe number ] modulo ( drx cycle ) ) < 1$$

where function ( ) may be a ceil(ing) function, a floor function, a round function, a round up function, a round down function, or a function of keeping the original value.

The definitions of each of the above elements is the same as abovementioned embodiments/examples.

### Example 6

In some embodiments, the DRX configuration may at least include Set 1 or Set 5 signaling. The functional relationship is associated with the SFN, subframe number, DRX cycle, drx-startOffset, C_cycle, C_offset and change time. In this example, the C_offset is a value used to change/determine the DRX cycle. The specific functional relationship may be:

$$[ ( SFN \times 10 ) + subframe number ] modulo ( function ( DRXcycle ) ) = function ( drx - StartOffset ) ,$$

where:
function(DRX cycle)=choice{DRX cycle, change time}

Where, function(DRX cycle) means choose a value as the DRX cycle. The UE counts the number of DRX cycles (i.e. Num) past if the DRX is performed. If mod(Num+1, change cycle)=0, function(DRX cycle)=change time, function(drx-startOffset)=drx-startOffset which is configured by the RRC signaling; otherwise, function(DRX cycle)=DRX cycle, the value of function(drx-startOffset) maybe changed according to a drx-startOffset which is configured by RRC signaling and a C_offset_A as below.

Function(drx-startOffset)=drx-startOffset+C_offset_A,
if [(SFN×10)+subframe number]>drx-startOffset and mod(Num, change cycle)=0, C_offset_A=C_offset; Otherwise, C_offset_A=0; and
function ( ) may be a ceil(ing) function, a floor function, a round function, a round up function, a round down function, or a function of keeping the original value.

In this example, the value of Function(drx-StartOffset) may be further adjusted to be a value of keeping the original value or getting the remainder of a division of drx-startOffset by the drx cycle.

### Example 7

In some embodiments, the DRX configuration may at least include Set 1 or Set 5 signaling. The functional relationship is associated with the SFN, subframe number, DRX cycle, drx-startOffset, C_offset and change time. In this example, the C_offset is a value used to change/determine the drx-startOffset. The specific functional relationship may be as follows:

$$[ ( SFN \times 10 ) + subframe number ] modulo ( drxCycle ) = function ( drx - startOffset ) ,$$

$$function ( drx - startOffset ) = drx - startOffset + C\_offset \_B ,$$

### Example 7-1

where:
if [(SFN×10)+subframe number]>drx-startOffset and [(SFN×10)+subframe number]mod(change time)=I, C_offset_B=C_offset; Otherwise, C_offset_B=0;
I is an integer value greater than or equal to 0(For example, I=0). In some embodiments, I is equal to the drx-startOffset.

### Example 7-2

where:
The UE counts the number of DRX cycles (Num) past if the DRX is performed. If mod(Num, change cycle)=0, C_offset_B=C_offset; Otherwise, C_offset_B=0;
The initial value of drx-startOffset is the drx-startOffset value configured by the RRC signaling. The value of the drx-startOffset in determined by a function which maybe/comprise iteration using the result of the last calculation of Function(drx-startOffset).

In this example, the value of Function(drx-StartOffset) may be further adjusted to be a value of keeping the original value or getting the remainder of a division of drx-startOffset by the drx cycle.

### Example 8

In some embodiments, the DRX configuration may at least include Set 1 or Set 5 signaling. The function relationship is associated with the SFN, subframe number, DRX cycle, drx-startOffset, change offset and change time. In an embodiment, the change time may be indicated by an original RRC signaling indicating a DRX long cycle. Furthermore, the DRX cycle may be indicated by an original RRC signaling indicating a DRX short cycle. The specific functional relationship may be as follows:

$$[ ( S F N \times 10 ) + subframe number ] modulo ( drx Cycle ) = function ( drx - StartOffset + change offset * floor ( [ S F N \times 10 ) + subframe number ] / change time ) , drx Cycle ) or$$

$$[ ( S F N \times 10 ) + subframe number ] modulo ( drx Cycle ) = drx - StartOffset + change offset * floor ( [ S F N \times 10 ) + subframe number ] / change time ) , or$$

$$[ ( S F N \times 10 ) + subframe number ] modulo ( drx Cycle ) = function ( drx - StartOffset + change offset * functionA ( [ S F N \times 10 ) + subframe number ] / change time ) , drx Cycle )$$

Where:
Function(A,B) represents mod(A,B).
functionA ( ) is a ceil function, a floor function, a round function, a round up function, a round down function, or a function of keeping the original value.

### Example 9

In this example, the following steps are performed by the UE:
Step (1): determining a DRX cycle according to Change time and change cycle

The change cycle (C_cycle) indicates the number of DRX cycle within a change time (C_time). Note that the change time (C_time) indicates a time interval or a period of time.

For example, in a change time, the DRX cycle value for the first (C_cycle−1) DRX cycle is equal to function(C_time/C_cycle), the last DRX cycle value is equal to C_time−(C_cycle−1)*function(C_time/C_cycle). the function may be round, round up, round down, keep the original value.
Step (2): determining a change offset according to the DRX cycle

For example, the last DRX cycle value=A, the other DRX cycle value=B, and change offset=A-B.
Step (3):

Determining whether the following functional relationship is true:

$$( S F N * 10 + subframe number ) modulo ( change time ) = start offset$$

a) If this function relationship is satisfied, start an on-duration timer or start the on-duration timer a slot offset after a (current) time-domain position,
b) Start a timer, the timer value is equal to the first DRX cycle value, counting the timer by 1 after a subframe;
c) If the timer expires, start an on-duration timer or start the on-duration timer after a slot offset. Reset the timer value to the next DRX cycle value.

Note that the function relationship in step (3) may change to the other functional relationships described in the present disclosure.

Specifically, step (1) is used to get the DRX cycle value according to the change time and change cycle. Specifically, step (1) and (2) are used to get the DRX cycle value and change offset according to the change time and change cycle. In some embodiments, only step (1) or step (1) and (2) are performed.

### Example 10

In some embodiment, there is provided a method for determining when to start the drx-onDurationTimer if a new RRC signaling is used. The method comprises:
starting the drx-onDurationTimer or starting the drx-onDurationTimer after the drx-SlotOffset from the beginning of a time domain position if a predefined condition is satisfied. The predefined condition includes at least one of the following: a functional relationship is satisfied.

In this example, the functional relationship is satisfied if one of the following satisfied:

$$reference S F N \times 10 + function ( j \times DRX Cycle ) = the time domain position ;$$

$$reference S F N \times 10 + subframe number + function ( j \times DRX Cycle ) = the time domain position ;$$

$$reference S F N \times 10 + reference subframe number + function ( j \times DRX Cycle ) = the time domain position ;$$

$$reference S F N \times 10 + subframe number + function ( j \times DRX Cycle ) + start offset = the time domain position ;$$

$$reference S F N \times 10 + reference subframe number + function ( j \times DRX Cycle ) + start offset = the time domain position ;$$

Where in some embodiments, j is an integer greater than 0. In some embodiments, j is an integer greater than or equal to 0. J means j-th DRX cycle.

Function ( ) may be a ceil function, a floor function, a round function, a round up function, a round down function, or a function of keeping the original value.

### Example 11

The functional relationship is associated with the reference SFN, SFN, subframe number, drx cycle, and drx-startOffset. The specific functional relationship may be one of:

$$( start offset + function ( j \times DRX Cycle ) ) modulo ( 1024 * 10 ) = ( S F N * 10 + subframe number ) ;$$

$$( reference S F N \times 10 + reference subframe number + function ( j \times DRX Cycle ) ) modulo ( 1024 * 10 ) = ( S F N * 10 + subframe number ) ;$$

$$( reference S F N \times 10 + function ( j \times DRX Cycle ) ) modulo ( 1024 * 10 ) = ( S F N * 10 + subframe number ) .$$

In the prior art, the drx-onDurationTimer starts after the drx-SlotOffset from the beginning of the subframe if at least the Long DRX cycle is used for a DRX group, and [(SFN×10)+subframe number] modulo (drx-LongCycle)=drx-StartOffset. For simplicity, [(SFN×10)+subframe number] modulo (drx-LongCycle)=drx-StartOffset is further referred as a first kind functional relationship in the following.

According to various embodiments and examples described above, the drx-onDurationTimer is started if a predefined condition satisfied. Therefore, the present disclosure provides methods to decide which kind of condition is used to determine whether to start the drx-onDurationTimer or start the drx-onDurationTimer after the drx-SlotOffset from the beginning of the subframe. For simplicity, a second kind functional relationship is used to refer to the function associated with a new DRX cycle parameter, a FPS parameter, a new RRC signaling or a non-integer parameter in the following.

In an embodiment, there is provided a method to determine one kind functional relationship (i.e. the first kind functional relationship or the second kind functional relationship) according to a high layer signaling (e.g. RRC signaling).

In an embodiment, if a new DRX parameter (e.g., new DRX cycle RRC signaling, new DRX startOffset RRC signaling, FPS RRC signaling, new RRC signaling) signaling is configured, the method comprises using the second kind functional relationship; otherwise, the method comprises using the first kind functional relationship.

In some embodiments, if a new DRX parameter signaling and an enable signaling are configured or an enable signaling indicates enable the new DRX parameter signaling or enable the second kind functional relationship, the method comprises using the second kind functional relationship; otherwise, the method comprises using the first kind functional relationship. The enable signaling indicates whether or not to enable the second kind functional relationship or whether or not to support new DRX parameter configuration.

In some embodiments, if an enable signaling is configured or an enable signaling indicates enable the new DRX parameter signaling or enable the second kind functional relationship, the method comprises using the second kind functional relationship; otherwise, the method comprises using the first kind functional relationship.

In some embodiments, the method comprises starting the drx-onDurationTimer or starting the drx-onDurationTimer after the drx-SlotOffset, from the beginning of the subframe, if a predefined condition is satisfied and/or a second predefined condition is satisfied.

The second predefined condition is satisfied if at least one of the following is true:
the Long DRX cycle is used for a DRX group;
if DCP (DCI with CRC scrambled by PS-RNTI) monitoring is configured for the active DL BWP and if DCP indication, associated with the current DRX cycle received from lower layer indicates to start the drx-onDurationTimer; or if all DCP occasion(s) in time domain, associated with the current DRX cycle, occurred in the Active Time considering grants/assignments/DRX Command MAC CE/Long DRX Command MAC CE received and Scheduling Request sent until 4 ms prior to start of the last DCP occasion, or during a measurement gap; or when the MAC entity monitors for a PDCCH transmission on the search space indicated by recovery Search Space Id of the Sp Cell identified by the C-RNTI, while the ra-Response Window is running; or if ps-Wakeup is configured with value true and DCP indication associated with the current DRX cycle has not been received from lower layers.

In some embodiments, if a new RRC signaling, used to determine a DRX cycle is configured, the predefined condition is satisfied if at least the Long DRX cycle is used for a DRX group, and a second kind functional relationship is satisfied. If an original RRC signaling, used to determine DRX cycle, is configured, the predefined condition is satisfied if at least the Long DRX cycle is used for a DRX group and a first kind functional relationship is satisfied. In some embodiments, determine a DRX cycle also means determine a start offset. The reason is if a start offset changes, the value of the corresponding DRX cycle also changes. In some embodiments, new RRC signaling used to determine the DRX cycle denotes the new RRC signaling.

In some embodiments, the predefined condition is satisfied if at least the Long DRX cycle is used for a DRX group, a new RRC signaling, used to determine DRX cycle, is configured, and a second kind functional relationship is satisfied. In some embodiments, the predefined condition is satisfied if at least the Long DRX cycle is used for a DRX group, an original RRC signaling, used to determine DRX cycle, is configured, and a first kind functional relationship is satisfied.

In some embodiments, the predefined condition is satisfied if at least a new RRC signaling, used to determine DRX cycle, is configured, and a second kind functional relationship is satisfied. In some embodiments, the predefined condition is satisfied if at least an original RRC signaling, used to determine DRX cycle, is configured, and a first kind functional relationship is satisfied.

In some embodiments, the predefined condition is satisfied if at least the Long DRX cycle is used for a DRX group, an enable signaling is configured or an enable signaling indicates enable the new DRX parameter signaling or enable the second kind functional relationship, and a second kind functional relationship is satisfied. In some embodiments, the predefined condition is satisfied if at least the Long DRX cycle is used for a DRX group, an enable signaling is not configured or an enable signaling indicates disable the new DRX parameter signaling or disable the second kind functional relationship, and a first kind functional relationship is satisfied.

In some embodiments, the predefined condition is satisfied if at least an enable signaling is configured, and a second kind functional relationship is satisfied. In some embodiments, the predefined condition is satisfied if at least an enable signaling is not configured, and a first kind functional relationship is satisfied.

In some embodiments, a UE capability signaling may indicate whether or not the UE supports new DRX parameters or non-integer DRX cycle values, where DRX cycle means DRX long cycle.

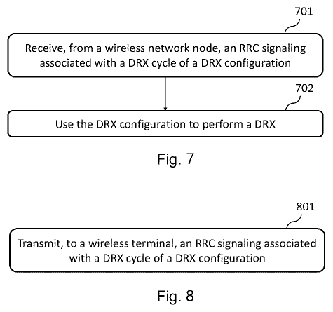

FIG. 7 shows a flowchart of a method according to an embodiment of the present disclosure. The method shown in FIG. 7 may be used in a wireless terminal (e.g. UE) and comprises the following steps:
Step 701: Receive, from a wireless network node, an RRC signaling associated with a DRX cycle of a DRX configuration.
Step 702: Use the DRX configuration to perform a DRX.

In FIG. 7, the wireless terminal receives an RRC signaling from a wireless network node (e.g. BS), wherein the RRC signaling is associated with a DRX cycle of a DRX configuration. The wireless terminal uses the DRX configuration to perform a DRX (e.g. DRX operation(s)).

In an embodiment, the DRX cycle has a non-integer value. That is, the DRX cycle is a non-integer DRX cycle.

In an embodiment, the RRC signaling comprises a value used for determining the non-integer value as the DRX cycle.

In an embodiment, the DRX cycle is a non-integer value determined by:

$$\frac{1000}{A} ( ms )$$

In this embodiment, the value A is indicated by the RRC signaling or the value A is an FPS parameter configured in the RRC signaling.

In an embodiment, the RRC signaling comprises/indicates the non-integer value of the DRX cycle.

In an embodiment, the RRC signaling comprises at least one of an FPS parameter, a QoS parameter and a data rate parameter which are used to determine the non-integer value of the DRX cycle.

In an embodiment, a unit of at least one parameter of the DRX configuration is millisecond.

In an embodiment, the RRC signaling does not comprise a DRX long cycle (i.e. drx-LongCycle) of the DRX configuration.

In an embodiment of the DRX long cycle (i.e. drx-LongCycle) being configured, the wireless terminal ignores the DRX long cycle.

In an embodiment, the wireless terminal disables a DRX short cycle (i.e. drx-ShortCycle) of the DRX.

In an embodiment, the DRX cycle having the non-integer value with F decimal places, wherein F is a positive integer.

In an embodiment, the RRC signaling indicates at least one parameter used to determine/adjust at least one of a DRX long cycle, the DRX cycle or a start offset of the DRX configuration. For example, the at least one parameter may comprise at least one of: a change offset, a change cycle, a change time.

In an embodiment, the DRX cycle is determined according to a change time and a change cycle. In this embodiment, the DRX cycles in one change cycle is determined by:
a value of each of first (change cycle-1) DRX cycles is equal to function (Change time/Change cycle),
a value of the last DRX cycle is equal to Change time−(Change cycle−1)*function(Change time/Change cycle),
wherein the function is a round function, a round up function, a round down function or a function of keeping the original value.

In an embodiment, a start offset of the DRX configuration is smaller than the maximum integer which is smaller than a non-integer value of the DRX cycle.

In an embodiment, a start offset of the DRX configuration is determined based on at least one parameter associated with jitter. For example, the at least one parameter associated with jitter comprises at least one of:
a jitter window indicating a time range of the jitter, or
a jitter offset indicating an offset between a time of generating a packet and a time of arrival of the packet.

In an embodiment, using the DRX configuration to perform the DRX comprises at least one of:
starting an on-duration timer or starting the on-duration timer after a slot offset at a time-domain position if a predefined condition is satisfied,
monitoring a PDCCH according to the DRX configuration.

In an embodiment, the predefined condition comprises at least one of:
the RRC signaling associated with the non-integer value is configured,
the RRC signaling indicating at least one parameter used to adjust or determine at least one of a DRX long cycle, a DRX cycle or a start offset of the DRX configuration is configured,
an enabling signaling associated with the DRX cycle of the DRX configuration is configured, or
a functional relationship is satisfied.

In an embodiment, the functional relationship is associated with at least one of a hyper system frame number, a reference system frame number, a reference subframe number, a system frame number, a subframe number, a frame per second, an index or a fixed value, a DRX cycle of the DRX configuration, a start offset of the DRX configuration, a change offset, a change time, or a change cycle.

In an embodiment, the functional relationship comprises:
a first difference between a second difference and a start offset of the DRX configuration is smaller than 1 and is greater than or equal to 0, wherein the second difference is between a total subframe number of subframes before the time-domain position and a total time of DRX cycles before the time-domain position. Note that, the total subframe number of subframes before the time-domain position may be equal to the “current total subframe number” discussed in the aforementioned embodiments. In addition, the total time of DRX cycles before the time-domain position is equal to the “current past DRX cycle time” discussed in the aforementioned embodiments.

In an embodiment, the functional relationship comprises:
a second difference is equal to a start offset of the DRX configuration, wherein the second difference is between a total subframe number of subframes before the time-domain position and a total time of DRX cycles before the time-domain position.

In an embodiment, wherein the total time of the DRX cycles before the time-domain position is determined by:

$$function ( \frac{S F N \times 10 + subframe number}{DRX - cycle} ) \times ( DRX - cycle ) ,$$

wherein SFN is a system frame number corresponding to the time-domain position, subframe number is a subframe index corresponding to the time-domain position, DRX-cycle is the value of the DRX cycle, and function is round, round down, round up or keep the original value.

In an embodiment, the second difference is rounded up to a minimum integer greater than the second difference or is rounded down to a maximum integer smaller than the second difference or is rounded to an integer.

In an embodiment, the total time of DRX cycles before the time-domain position is rounded up to a minimum integer greater the total cycle number or is rounded down to a maximum integer smaller than the total cycle number or rounded to an integer.

In an embodiment, the functional relationship comprises:
a third difference between a remainder and a start offset of the DRX configuration is smaller than 1 and is greater than or equal to 0, wherein the remainder is determined by a division of a total subframe number of subframes before the time-domain position by the DRX cycle.

In an embodiment, the functional relationship comprises:
a remainder is equal to a start offset of the DRX configuration, wherein the remainder is determined by a division of a total subframe number of subframes before the time-domain position by the DRX cycle.

In an embodiment, the remainder is rounded up to a minimum integer greater than the remainder or is rounded down to a maximum integer smaller than the remainder or round.

In an embodiment, the functional relationship comprises:
a remainder of a division of a total subframe number of subframes before the time-domain position by a DRX long cycle of the DRX configuration is equal to a function of a start offset of the DRX configuration, a change offset, and a change time, wherein the function is a remainder of a division of a modified start offset by the DRX cycle, wherein the modified start offset is a sum of the start offset and a modified value.

In an embodiment, the modified value is a product of a change offset and a function of a division of the total subframe number of subframes before the time-domain position by the Change time, wherein the function is round up, round down, round, or keep the original value.

In an embodiment, the functional relationship comprises:
a remainder of a division of a total subframe number of subframes before the time-domain position by a DRX cycle of the DRX configuration is equal to a start offset of the DRX configuration,
wherein at least one of the long DRX cycle or the start offset is determined according to a change offset comprised in the RRC signaling.

In an embodiment, the start offset is determined according to the change offset comprised in the RRC signaling by:
if the total subframe number of subframes before the time-domain position is greater than the start offset, and a remainder of a division of the total subframe number of subframes before the time-domain position by the change time is equal to an integer, wherein the integer is smaller than the change time,
the start offset is a value of a sum of the start offset and the change offset;
otherwise, the start offset remains the same.

In an embodiment, the integer smaller than the change time is predefined or configured by the RRC signaling or configured to be the same with the start offset.

In an embodiment, the start offset is adjusted to be a remainder of a division of the start offset by the DRX cycle.

In an embodiment, the functional relationship comprises the time domain position is a subframe corresponding to:

$$reference S F N \times 10 + function ( j \times DRX cycle ) , or$$

$$reference S F N \times 10 + reference subframe number + function ( j \times DRX cycle ) ,$$

where reference SFN is an SFN configured by the RRC signaling, reference subframe number is a subframe number configured by the RRC signaling, j is an integer greater than or equal to 0, and function is a round up function or a round down function or a function of keeping the original value.

In an embodiment, the total subframe number of subframes before the time-domain position is determined by:

$$S F N \times 10 + subframenumber ,$$

$$( S F N - reference S F N ) \times 10 + subframenumber , ( H - S F N - reference H - S F N ) * 1024 * 10 + S F N \times 10 + subframenumber ,$$

$$H - S F N * 1024 * 10 * S F N * 10 + subframenumber , or S F N \times 10 + subframenumber - startoffset$$

where SFN is a system frame number corresponding to the time-domain position and subframe number is a subframe index corresponding to the time-domain position, and H-SFN is a hyper system frame number, reference H-SFN is a reference hyper system frame number configured by the RRC signaling.

In an embodiment, if the DRX cycle associated with the RRC signaling is an integer (i.e. integer DRX cycle), the functional relationship associated with DRX operation and/or monitoring PDCCH is:

$$[ ( S F N \times 10 ) + subframe number ] modulo ( drx - Long Cycle ) = drx - StartOffset .$$

FIG. 8 shows a flowchart of a method according to an embodiment of the present disclosure. The method shown in FIG. 8 may be used in a wireless network node (e.g. BS) and comprises the following steps:
Step 801: transmitting, to a wireless terminal, an RRC signaling associated with a DRX cycle of a DRX configuration.

In this embodiment, the wireless network node transmits an RRC associated with a DRX cycle of a DRX configuration. to a wireless terminal (e.g. UE). For example, the DRX cycle may has a non-integer value (i.e. non-integer DRX cycle).

In an embodiment, the RRC signaling comprises a value used for determining a non-integer value as the DRX cycle.

In an embodiment, the DRX cycle is a non-integer value determined by:

$$\frac{1000}{A} ( ms )$$

wherein the value A is indicated by the RRC signaling or the value A is an FPS parameter configured in the RRC signaling.

In an embodiment, the RRC signaling comprises the non-integer value of the DRX cycle.

In an embodiment, the RRC signaling comprises at least one of an FPS parameter, a QoS parameter or a data rate parameter used to determine the non-integer value of the DRX cycle.

In an embodiment a unit of at least one parameter of the DRX configuration is millisecond.

In an embodiment, the RRC signaling does not comprise a DRX long cycle (i.e. drx-LongCycle) of the DRX configuration.

In an embodiment, the DRX cycle is a non-integer value having F decimal places, wherein F is a positive integer.

In an embodiment, the RRC signaling indicates at least one parameter used to determine at least one of the DRX cycle, a DRX long cycle or a start offset of the DRX configuration.

In an embodiment, the RRC signaling indicates at least one of:
a change offset, used to determine at least one of a DRX long cycle or a start offset of the DRX configuration,
a change cycle, indicating a cycle number used to determine the change offset, or
a change time, indicating a time used to determine at least one of a change in the DRX long cycle or in a start offset of the DRX configuration.

In an embodiment a start offset of the DRX configuration is smaller than the maximum integer which is smaller than the non-integer value.

In an embodiment, a start offset of the DRX configuration is determined based on at least one parameter associated with jitter. For example, the at least one parameter associated with jitter comprises at least one of
a jitter window indicating a time range of the jitter, or
a jitter offset indicating an offset between a time of generating a packet and a time of arrival of the packet.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
receiving, from a wireless network node, a radio resource control RRC signaling associated with a discontinuous reception DRX cycle of a DRX configuration, and
using the DRX configuration to perform a DRX.

2. The wireless communication method of claim 1,
wherein the RRC signaling comprises a value used for determining a non-integer value as the DRX cycle; or
wherein the DRX cycle is a non-integer value determined by:
$$\frac{1000}{A} ( ms ) ,$$
wherein the value A is indicated by the RRC signaling or the value A is a frame per second parameter configured in the RRC signaling; or
wherein the RRC signaling comprises a non-integer value of the DRX cycle; or
wherein the RRC signaling comprises at least one of a frame per second parameter, a quality-of-service parameter or a data rate parameter used to determine a non-integer value of the DRX cycle.

3.-5. (canceled)

6. The wireless communication method of claim 1,
wherein a unit of at least one parameter of the DRX configuration is millisecond;
wherein the RRC signaling does not comprise a DRX long cycle of the DRX configuration; or
further comprising: ignoring a DRX long cycle in the RRC signaling; or
further comprising: disabling a DRX short cycle of the DRX; or
wherein the DRX cycle is a non-integer value having F decimal places, wherein F is a positive integer; or
wherein the RRC signaling indicates at least one parameter used to determine at least one of a DRX long cycle, the DRX cycle or a start offset of the DRX configuration, wherein the at least one parameter comprises at least one of: a change offset, a change cycle, or a change time; or
wherein the DRX cycle is determined according to a change time and a change cycle, wherein the DRX cycles in one change cycle is determined by: a value of each of first (change cycle−1) DRX cycles is equal to function(change time/change cycle), a value of the last DRX cycle is equal to Change time−(Change cycle−1)*function(change time/change cycle), wherein the function is a round function, a round up function, a round down function or a function of keeping the original value; or
wherein a start offset of the DRX configuration is smaller than a maximum integer which is smaller than a non-integer value of the DRX cycle; or
wherein a start offset of the DRX configuration is determined based on at least one parameter associated with jitter.

7.-14. (canceled)

15. The wireless communication method of claim 6, wherein the at least one parameter associated with jitter comprises at least one of:
a jitter window indicating a time range of the jitter, or
a jitter offset indicating an offset between a time of generating a packet and a time of arrival of the packet.

16. The wireless communication method of claim 1, wherein using the DRX configuration to perform the DRX comprises at least one of:
starting an on-duration timer or starting the on-duration timer after a slot offset at a time-domain position if a predefined condition is satisfied, or
monitoring a physical downlink control channel, PDCCH, according to the DRX configuration.

17. The wireless communication method of claim 16, wherein the predefined condition comprises at least one of:
the RRC signaling associated with the non-integer value is configured,
the RRC signaling indicating at least one parameter used to adjust or determine at least one of a DRX long cycle, a DRX cycle or a start offset of the DRX configuration is configured,
an enabling signaling associated with the DRX cycle of the DRX configuration is configured, or
a functional relationship is satisfied.

18. The wireless communication method of claim 17, wherein the functional relationship is associated with at least one of a hyper system frame number, a reference system frame number, a reference subframe number, a system frame number, a subframe number, a frame per second, an index or a fixed value, a DRX cycle of the DRX configuration, a start offset of the DRX configuration, a change offset, a change time, or a change cycle.

19. The wireless communication method of claim 17,
wherein the functional relationship comprises:
a first difference between a second difference and a start offset of the DRX configuration is smaller than 1 and is greater than or equal to 0, wherein the second difference is between a total subframe number of subframes before the time-domain position and a total time of DRX cycles before the time-domain position; or
wherein the functional relationship comprises: a second difference is equal to a start offset of the DRX configuration, wherein the second difference is between a total subframe number of subframes before the time-domain position and a total time of DRX cycles before the time-domain position.

20. (canceled)

21. The wireless communication method of claim 19, wherein the total time of the DRX cycles before the time-domain position is determined by:
$$function ( \frac{S F N \times 10 + subframe number}{drx - cycle} ) \times ( drx - cycle ) ,$$
wherein SFN is a system frame number corresponding to the time-domain position, subframe number is a subframe index corresponding to the time-domain position, drx-cycle is the value of the DRX cycle, and function is round, round down, round up or keep the original value.

22. The wireless communication method of claim 19,
wherein the second difference is rounded up to a minimum integer greater than the second difference or is rounded down to a maximum integer smaller than the second difference or is rounded to an integer; or
wherein the total time of DRX cycles before the time-domain position is rounded up to a minimum integer greater the total cycle number or is rounded down to a maximum integer smaller than the total cycle number or rounded to an integer.

23. (canceled)

24. The wireless communication method of claim 17, wherein the functional relationship comprises:
a third difference between a remainder and a start offset of the DRX configuration is smaller than 1 and is greater than or equal to 0, wherein the remainder is determined by a division of a total subframe number of subframes before the time-domain position by the DRX cycle; or
a remainder is equal to a start offset of the DRX configuration, wherein the remainder is determined by a division of a total subframe number of subframes before the time-domain position by the DRX cycle; or
a remainder of a division of a total subframe number of subframes before the time-domain position by a DRX long cycle of the DRX configuration is equal to a function of a start offset of the DRX configuration, a change offset, and a change time, wherein the function is a remainder of a division of a modified start offset by the DRX cycle, and wherein the modified start offset is a sum of the start offset and a modified value; or
a remainder of a division of a total subframe number of subframes before the time-domain position by a DRX cycle of the DRX configuration is equal to a start offset of the DRX configuration, wherein at least one of the long DRX cycle or the start offset is determined according to a change offset comprised in the RRC signaling.

25. (canceled)

26. The wireless communication method of claim 24,
wherein the remainder is rounded up to a minimum integer greater than the remainder or is rounded down to a maximum integer smaller than the remainder or round; or
wherein the modified value is a product of a change offset and a function of a division of the total subframe number of subframes before the time-domain position by the Change time, wherein the function is round up, round down, round, or keep the original value; or
wherein the start offset is determined according to the change offset comprised in the RRC signaling by: if the total subframe number of subframes before the time-domain position is greater than the start offset, and a remainder of a division of the total subframe number of subframes before the time-domain position by the change time is equal to an integer, wherein the integer is smaller than the change time, the start offset is a value of a sum of the start offset and the change offset; otherwise, the start offset remains the same; or
wherein the integer smaller than the change time is predefined or configured by the RRC signaling or configured to be the same with the start offset; or
wherein the start offset is adjusted to be a remainder of a division of the start offset by the DRX cycle.

27.-32. (canceled)

33. The wireless communication method of claim 17, wherein the functional relationship comprises the time domain position is a subframe corresponding to:
$$reference S F N \times 10 + function ( j \times DRX cycle ) , or$$
$$reference S F N \times 10 + reference subframe number + function ( j \times DRX cycle ) ,$$
where reference SFN is a system frame number configured by the RRC signaling, reference subframe number is a subframe number configured by the RRC signaling, j is an integer greater than or equal to 0, and function is a round up function or round down function or a function of keeping the original value.

34. The wireless communication method of claim 19, wherein the total subframe number of subframes before the time domain position is determined by:
$$S F N \times 10 + subframe number ,$$
$$( S F N - reference S F N ) \times 10 + subframe number ,$$
$$( H - S F N - reference H - S F N ) * 1024 * 10 + S F N \times 10 + subframe number ,$$
$$H - S F N * 1024 * 10 + S F N * 10 + subframe number , or$$
$$S F N \times 10 + subframe number - start offset$$
where SFN is a system frame number corresponding to the time-domain position and subframe number is a subframe index corresponding to the time-domain position, and H-SFN is a hyper system frame number, reference H-SFN is a reference hyper system frame number configured by the RRC signaling, reference SFN is a system frame number configured by the RRC signaling.

35. A wireless communication method for use in a wireless network node, the method comprising:
transmitting, to a wireless terminal, a radio resource control RRC signaling associated with a discontinuous reception (DRX) cycle of a DRX configuration.

36. The wireless communication method of claim 35, wherein the RRC signaling comprises a value used for determining a non-integer value as the DRX cycle.

37. The wireless communication method of claim 35,
wherein the DRX cycle is a non-integer value determined by:
$$\frac{1000}{A} ( ms ) ,$$
wherein the value A is indicated by the RRC signaling or the value A is a frame per second parameter configured in the RRC signaling; or
wherein the RRC signaling comprises a non-integer value of the DRX cycle;
wherein the RRC signaling comprises at least one of a frame per second parameter, a quality-of-service parameter or a data rate parameter used to determine a non-integer value of the DRX cycle; or
wherein the RRC signaling does not comprise a DRX long cycle of the DRX configuration; or
wherein the DRX cycle is a non-integer value having F decimal places, wherein F is a positive integer; or
wherein the RRC signaling indicates at least one parameter used to determine at least one of the DRX cycle, a DRX long cycle or a start offset of the DRX configuration; or
wherein the RRC signaling indicates at least one of: a change offset, used to determine at least one of a DRX long cycle or a start offset of the DRX configuration, a change cycle, indicating a cycle number used to determine the change offset, or a change time, indicating a time used to determine at least one of a change in the DRX long cycle or in a start offset of the DRX configuration; or
wherein a start offset of the DRX configuration is smaller than a maximum integer which is smaller than the non-integer value; or
wherein a start offset of the DRX configuration is determined based on at least one parameter associated with jitter.

38.-46. (canceled)

47. The wireless communication method of claim 37, wherein the at least one parameter associated with jitter comprises at least one of:
a jitter window indicating a time range of the jitter, or
a jitter offset indicating an offset between a time of generating a packet and a time of arrival of the packet.

48. A wireless terminal, comprising:
a communication unit, configured to receive, from a wireless network node, a radio resource control RRC signaling associated with a discontinuous reception; DRX cycle of a DRX configuration, and
a processor, configured to using the DRX configuration to perform a DRX.

49.-51. (canceled)

52. A computer program product, comprising a computer-readable program medium code stored thereupon, the code, when executed by a processor, causing the processor to implement the wireless communication method of claim 1.
